(19) United States
(12) Patent Application Publication
(10) Pub. No.: US 2019/0362431 A1
(43) Pub. Date: Nov. 28, 2019

(54) MOBILE APPLICATION AND SYSTEM FOR CONNECTING USERS TO CARRIERS TO FACILITATE AVAILABILITY OF SHORT-TERM, ON-DEMAND INSURANCE

(71) Applicant: Verifly Technology, Limited, Dundrum (IE)

(72) Inventors: Eugene S. Hertz, Briarcliff Manor, NY (US); Jay P. Bregman, New York, NY (US); Lanzhi Wu, Xiamen (CN); Edward Dew, Chester, NJ (US)

(21) Appl. No.: 16/419,693

(22) Filed: May 22, 2019

Related U.S. Application Data
(60) Provisional application No. 62/674,915, filed on May 22, 2018.

(51) Int. Cl. G06Q 40/08; G06Q 10/06

(52) U.S. Cl. CPC G06Q 40/08; G06Q 10/0635

(57) ABSTRACT

A system comprising an application server configured to communicate with a client application of a client device that presents an interface for purchasing an insurance policy, the interface comprising a graphical representation including: a carousel for selecting one of a plurality of risk groups, an amount of coverage, and a coverage term on an hourly, daily, or monthly duration, wherein the plurality of risk groups include classes of occupational activities to be covered in the insurance policy. The application server comprises a quoting service component configured to receive a selection of risk group, amount of coverage, and coverage term from the interface, and generate quote data using a concentration ratio of an annual exposure based on the selected risk group, amount of coverage, and the coverage term.

### CROSS REFERENCE TO RELATED APPLICATION

This application claims the priority of U.S. Provisional Application No. 62/674,915, entitled “MOBILE APPLICATION AND SYSTEM FOR CONNECTING USERS TO CARRIERS TO FACILITATE AVAILABILITY OF SHORT-TERM, ON-DEMAND INSURANCE,” filed on May 22, 2018, the disclosure of which is hereby incorporated by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

### Field of the Invention

This application generally relates to mobile applications and supporting systems, and more particularly to a mobile application that may be accessible through or executed by mobile devices to connect users to carriers which provide on-demand short-term business insurance policies.

### Description of the Related Art

Conventionally, purchasing business insurance may include an insurance broker sitting together with an applicant to discuss the nature of the business (risk) that is to be covered. The broker discusses the business and may determine that the applicant falls into one or more “classes” of activities. These are typically called ISO (Insurance Services Office) classes but may also be proprietary to the insurer. There are over 1,000 classes of business from which the risk may be selected.

The purpose of these individual ISO classes is to properly assign “loss costs.” A loss cost may include a historical accounting of claims paid for a given activity. For example, the lost cost for ISO class code “98677 Roofing—commercial” is much higher than “96611 Interior Decorators.” Over time, the ISO classes may accumulate historical claims and loss data for these types of activities and the insurance losses accumulated, e.g., for commercial roofing were greater than the accumulated losses for interior decorators. These loss costs can be important in the calculation of the premium of the policy.

Today, many people have multiple jobs, especially in today's “gig-economy.” In the traditional insurance world, this would require the user to select multiple classes to properly cover the risk of their activities. However, as some activities have higher loss costs than others, a policy covering an activity containing a higher loss cost activity may have a higher premium associated with it than policies covering activities with a lower loss cost. In order to properly rate and price a policy, the activities being covered should be represented in order for the insurance carrier to receive premium commensurate with the historical losses represented by such activities.

Additionally, the insurance broker may need to determine “exposure” in order to accurately determine the premium. Exposure may be based on payroll of the company or revenue of the company. A company with a larger payroll would have more employees performing tasks and therefore a higher overall exposure. Revenue is another method—larger companies with higher revenues will typically have higher risk exposure. The insurance broker may correlate either payroll or revenue associated with the various ISO classes the business will perform.

The above-mentioned procedures are quite complex and require the expertise of an insurance broker. Thus, there is a need for a more convenient self-selection system that allows individual purchasers of insurance to easily and successfully purchase their own business insurance.

### SUMMARY OF THE INVENTION

The present invention provides a system comprising an application server. According to one embodiment, the application server is configured to communicate with a client application of a client device that presents an interface for purchasing an insurance policy, the interface comprising a graphical representation including: a carousel for selecting one of a plurality of risk groups, an amount of coverage, and a coverage term on an hourly, daily, or monthly duration, wherein the plurality of risk groups include classes of occupational activities to be covered in the insurance policy. The application server comprising a quoting service component configured to: receive a selection of risk group, amount of coverage, and coverage term from the interface, and generate quote data using a concentration ratio of an annual exposure based on the selected risk group, amount of coverage, and the coverage term, a payment service component configured to solicit payment for the insurance policy based on the quote data, process the payment, and facilitate coverage under the insurance policy and an account management service component configured to transmit details of the insurance policy to the client application and facilitate requests for extending the coverage term of the insurance policy.

The quote data may be used by the client application to generate a graphic representation of an insurance product offering on the interface. In one embodiment, the quote data includes one or more of vector graphics data, markup language data, graphics, and images. The quote data may also include coverage, pricing, and duration based on information provided from programmable business rules and databases. The application server further comprises a customer service component configured to establish communication with a call center via the client application. The customer service component may be further configured to render proof of insurance identification cards or documents.

The carousel may include one or more risk group cards including pricing, risk group description, and activities associated with a given risk group. A risk group may include a plurality of constituent risk classes wherein a predetermined weighting factor is applied to each of the constituent risk class. The plurality of risk groups may include a custom group associated with work order types of a company and including risk classes specified according to the company. The plurality of risk groups may include policy level exclusions. The plurality of risk groups may include group level exclusions that are added to the insurance policy and are specific to group risks configured on the insurance policy. The insurance policy can be extended an hourly duration or a new end date. In another embodiment, the insurance policy includes coverage for one or more crew members.

In one embodiment, non-transitory computer-readable media comprising program code that when executed by a programmable processor causes execution of a method for presenting an interface on a client device comprises computer program code for communicating with a client application of a client device that presents an interface for purchasing an insurance policy, the interface comprising a graphical representation including a carousel for selecting one of a plurality of risk groups, an amount of coverage, and a coverage term on an hourly, daily, or monthly duration, wherein the plurality of risk groups include classes of occupational activities to be covered in the insurance policy, computer program code for receiving a selection of risk group, amount of coverage, and coverage term from the interface, computer program code for generating quote data using a concentration ratio of an annual exposure based on the selected risk group, amount of coverage, and the coverage term, computer program code for soliciting payment for the insurance policy based on the quote data, process the payment, and facilitate coverage under the insurance policy, computer program code for transmitting details of the insurance policy to the client application, and computer program code for facilitating requests for extending the coverage term of the insurance policy.

The quote data may include coverage, pricing, and duration based on information provided from programmable business rules and databases. The carousel includes one or more risk group cards including pricing, risk group description, and activities associated with a given risk group. A risk group may include a plurality of constituent risk classes wherein a predetermined weighting factor is applied to each of the constituent risk class. In one embodiment, the plurality of risk groups includes a custom group associated with work order types of a company and including risk classes specified according to the company. The plurality of risk groups may also include group level exclusions that are added to the insurance policy and are specific to group risks configured on the insurance policy. In another embodiment, the insurance policy may include coverage for one or more crew members.

### BRIEF DESCRIPTION OF THE DRAWINGS

The invention is illustrated in the figures of the accompanying drawings which are meant to be exemplary and not limiting, in which like references are intended to refer to like or corresponding parts.

FIG. 1 illustrates a computing system according to an embodiment of the present invention.

FIG. 2 illustrates block diagram of an exemplary computing architecture according to an embodiment of the present invention.

FIG. 3 illustrates a block diagram of a menu-driven process provided by an insurance shopping client according to an embodiment of the present invention.

FIGS. 4A and 4B illustrate an exemplary group card according to an embodiment of the present invention.

FIGS. 5A and 5B illustrate an exemplary interface for selecting a custom group according to an embodiment of the present invention.

FIG. 6 illustrates an exemplary policy builder interface according to an embodiment of the present invention.

FIG. 7 illustrates exemplary group description and coverage according to an embodiment of the present invention.

FIG. 8 illustrates an active policy screen according to an embodiment of the present invention.

FIGS. 9 and 10 present exemplary screens for crew coverage according to an embodiment of the present invention.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the present invention. Likewise, a reasonably broad scope for claimed or covered subject matter is intended. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

The present application discloses systems and methods for providing an interface that generates on-demand and real-time information for purchasing insurance coverage for occupational or job-related activities on a short-term basis via a mobile application. Additionally, other forms of insurance beyond general liability (e.g., property, workers compensation, umbrella/excess, professional liability/errors and omissions, etc.) may be provided. Insurance data can be calculated in real-time and as such can more accurately reflect appropriate coverage for a situation. On-demand insurance may be provided to cover people who work independently—such as photographers, handymen, disc jockeys, and others. With the growing number of freelance workers, many clients require them to be insured. As such, freelance workers need easy, mobile access to quick, inexpensive, short-term insurance so they never lose a potential job or have to call an insurance broker.

Insurable activities may include:
construction (carpentry, finishing, electrical, flooring, siding and walls),
professional services (photography, videography, hair stylists, nail artists, yoga/personal training, computer programming, support, and repair),
events and entertainment (event planning and staffing, entertainment (e.g. musicians, magicians, disc jockeys (“DJ's”), nature guides and tours)),
home & garden (jobs in and around the house including handy work, furniture assembly, painting, landscaping, and lighting),
pets (grooming, training, walking, sitting),
drone aviation liability,
commercial general liability,
business owners policy,
inland marine,
property,
commercial auto,
workers comp, and
Personal accident.

The system includes a computing platform that is accessible via a mobile application that allows a user to select risk, pricing of the risk, establishment of exposure to that risk based on a time frame selected, types of coverage required, limits and additional insureds, and other factors. Additionally, the mobile application may request short duration policies from one hour to one month (and even up to one year), short-term policy rating, simplified risk class grouping for easy self-identification, and risk group mapping to other activity classification systems. As such, the disclosed system allows every-day small businesses to quickly access the insurance they need.

The system may provide a customized point-of-sale application that supports insurance quotes, insurance related sales, and insurance services at any time and in any place (e.g., 24 hours a day, 7 days a week). Quoting and buying insurance through the system and mobile application may directly access data centers or telephone call centers and provide screening, interrogation, and/or queries based on the unique information gathered from a user's input. Some quoting processes may facilitate automated requests made and transmitted by a user's client device to destinations, such as remote analytic services, government services, data warehouses, local or remote databases, and/or third-party vendors. The mobile application may also include or support automatic prefilling of forms, such as electronic forms, without requiring users to manually enter or re-enter information. A text-to-speech engine and/or speech-to-text engine may further solicit and capture information.

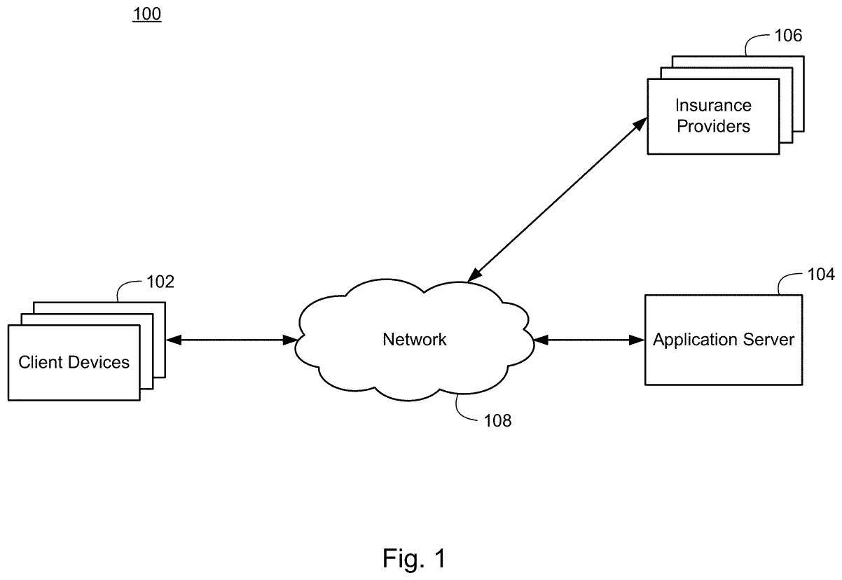

FIG. 1 illustrates a computing system 100 that supports mobile users and one or more insurance providers according to an embodiment of the present invention. The system presented in FIG. 1 includes client devices 102, application server 104, insurance providers 106, and network 108. Client devices 102 may comprise computing devices (e.g., desktop computers, television devices, terminals, laptops, personal digital assistants (PDA), cellular phones, smartphones, tablet computers, e-book readers, smart watches and wearable devices, or any computing device having a central processing unit and memory unit capable of connecting to a network). The client devices 102 may further include one or more physical or virtual keyboards, mass storage, one or more accelerometers, one or more gyroscopes, global positioning system (GPS) or other location identifying type capability, or a display with a high degree of functionality, such as a touch-sensitive color 2D or 3D display.

In one embodiment, client devices 102 may include one or more applications stored on a non-transitory media including an insurance shopping client that may be executed by a processor of the client devices 102. An interface may link the insurance shopping client on the client devices 102 to application server 104 over network 108 to convey commands and information or data between the client devices 102 and the application server 104 by ways, such as notifications, sharing, uploading, downloading, importing etc. The insurance shopping client may request services provided by programs run on the application server 104. The commands and data that are exchanged between the client devices 102 and the application server 104 may be processed. Application server 104 may comprise a program or a programmed computer, for example, that responds to commands from client device 102. Servers, as described herein, may vary widely in configuration or capabilities but are comprised of at least a special-purpose digital computing device including at least one or more central processing units and memory. A server may also include one or more of mass storage devices, power supplies, wired or wireless network interfaces, input/output interfaces, and operating systems, such as Windows Server, Mac OS X, Unix, Linux, FreeBSD, or the like.

Network 108 may be any suitable type of network allowing transport of data communications across thereof. The network 108 may couple devices so that communications may be exchanged, such as between servers and client devices or other types of devices, including between wireless devices coupled via a wireless network, for example. A network may also include mass storage, such as network attached storage (NAS), a storage area network (SAN), cloud computing and storage, or other forms of computer or machine-readable media, for example. In one embodiment, the network may be the Internet, following known Internet protocols for data communication, or any other communication network, e.g., any local area network (LAN) or wide area network (WAN) connection, cellular network, wire-line type connections, wireless type connections, or any combination thereof. Communications and content stored and/or transmitted to and from client devices 102 may be encrypted using, for example, the Advanced Encryption Standard (AES) with a 128, 192, or 256-bit key size, or any other encryption standard known in the art.

The insurance shopping client may include software routines or source code stored in a non-transitory media that provide a customized point-of-sale for insurance and insurance-related sales. The insurance shopping client may gather information from prospects and/or existing customers, process the information via application server 104, and deliver insurance quotes that may be customizable to the user by premium, plan type, coverages, deductible, effective policy date, etc. Some information gathered in the quoting process may be validated through location services (e.g., global positioning sensors, geo-tagging software, etc.) in or available to the client devices 102, for example, may capture the user's geographic location to confirm the user's location in order to price a policy. The insurance shopping client may further allow prospects to change to an existing insurance policy (e.g., policy endorsement, coverage changes, changes in insurance limits, changes in insurance deductibles, etc.).

A prospect may specify the details of a potential insurance purchase through an interface, such as a graphical user interface on the client devices 102. Information may be provided through keyboard input, verbal, written, and/or gestures on client devices 102. The information gathering process may solicit different information from prospects based on the information gathered and insurer criteria (as specified by insurance providers 106). The insurance shopping client may also gather personal information needed to process quotes, such as the prospect's first name, last name, date of birth, street address, city, state, zip, social security number, gender, and/or other data. Gathered information may also include information from an autofill feature that is configured to operate with the insurance shopping client to automatically prefill or suggest data to prefill one or more data fields.

The insurance shopping client may transmit the information an insurer needs to provide a quote (e.g., to the insurance server 106). After selecting or customizing one or more parameters such as a desired premium, plan type, coverages, deductible, effective date, etc., using the insurance shopping client on client devices 102, a request based on the selection and customization may be received and processed by application server 104. Application server 104 may transmit the request to the insurance providers 106 where quotes may be generated and delivered to the client devices 102 through the application server 104. The insurance providers 106 may comprise one or more servers that process the user transmitted information to validate it and allows the application server 104 to deliver a quote to the client device 102. The quote may be delivered by the application server 104 through a secure transmission of a path or address of where the quote resides (e.g., a uniform resource locator) via a secure network, a document or file from insurance providers 106. The quote may include conditions, such as a period for acceptance. If adjustments are required, the desired or adjustable parameters may be further modified graphically, textually, etc. by directly entering data or information into the client devices 102.

The insurance shopping client may allow users to sign and/or accept the quote generated by the insurance providers 106 on client devices 102 and transmit the acceptance to the insurance providers 106. Acceptance of a quote on client devices 102 may include a prospect's acknowledgement, an electronic signature, voice recognition, an accepted gesture, etc. In some embodiments, the client devices 102 may include touch screens configured with the insurance shopping client to accept printing, handwriting, graphics and finger movement, stylus movements that may be captured by many types of screens, such as pressure sensitive screens, capacitive screens, projected capacitive screens, acoustic wave and/or infrared screens, etc. The acceptance may be received, encoded, and transmitted with a time and date stamp rendered by the prospect's mobile device 106 or added to the acknowledgment data (e.g., payload, header, metadata) when received at the insurance providers 106.

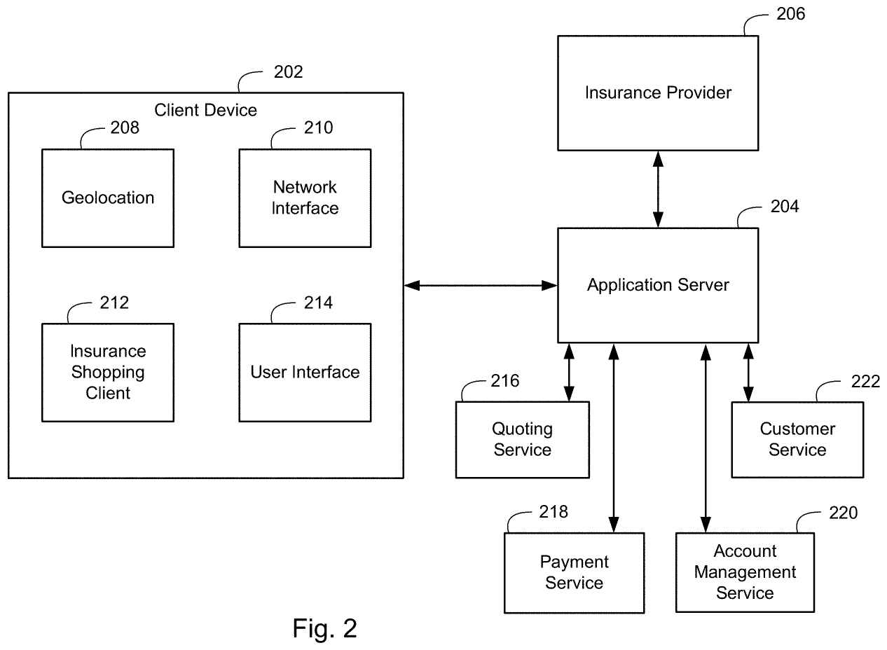

FIG. 2 presents a block diagram of an exemplary computing architecture according to an embodiment of the present invention. The computing architecture may be implemented in a client/server architecture, a cloud computing architecture, a mainframe architecture, a software as a service mode, and the like, that are all within scope of this disclosure. Client device 202 includes a geolocation component 208, network interface 210, insurance shopping client 212, and user interface 214. Insurance shopping client 212 may allow users to request a purchase or management of existing insurance policies from application server 204 via network interface 210. Application server 204 may include and provide access to quoting service 216, payment service 218, account management service 220, and customer service 222 through insurance shopping client 212. Each of quoting service 216, payment service 218, account management service 220, and customer service 222 may comprise modules or components including one or more computing devices, software or logic embodied in non-transitory media, virtualizations, or communication connections.

Quoting service 216 may provide a quote to a user before purchasing insurance or a change to an existing insurance policy. A user may register with account management service 220 and then specify the details of the potential insurance purchase by inputting data using user interface 214. User interface 214 may include a touch-screen that recognizes and detects hand touch and gestures and/or devices operable to receive and display data. The quoting service 216 may receive a selection or customization of one or more parameters for policy coverage and deliver quote data to the client device 202. Information received by the quoting server 216 may be verified based on the user's location by retrieving data from geolocation component 208.

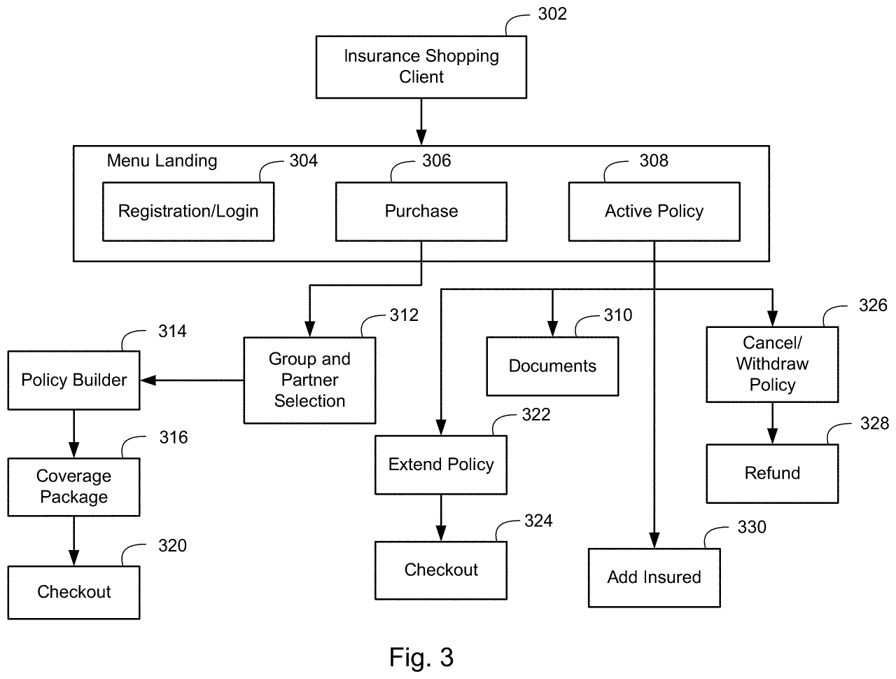

Insurance shopping client 212 may use the quote data to generate a graphic representation of an insurance product offering on user interface 214. For example, the quote data may include one or more of vector graphics data, markup language data (e.g., HTML, XHTML, SGML, etc.), graphics, images, and/or any other type of data for displaying information. The quote data may include coverage, pricing, and duration based on information provided from insurance providers 206. Insurance providers 206 may comprise servers executing programmable rules and databases including rates tables. Additional details of generating a quote is described in further detail with respect to the description of FIG. 3.

The quoting service 216 may receive an acceptance of a quote and direct the user to payment service 218. Payment service 218 may process billing and payment in exchange for insurance coverage under the quoted policy (e.g., enable payment and verification via a credit card, on-line check, electronic fund transfers, etc.). Account management service 220 may further allow a user to locate and retrieve information (e.g., viewing of coverages and policy documents) requested by the user from insurance providers 206 and provide the information to the user via user interface 214. Alternatively, the requested information may be stored at and retrieved from application server 204. The account management service 220 may also provide updating of the user's existing information and facilitate real-time updating of some or all of the user's insurance policy parameters and provide functionality that implements policy changes on-request (e.g., in real-time, after minimal delay, etc.).

Customer service 222 may provide means for establishing communication with a customer representative at a call center directly via insurance shopping client 212. Exemplary communication means include telephone, live chat, or email. A user may also access customer service 222 to provide dynamic or real-time rendering of proof of insurance identification cards or documents that may identify the policy number, coverage period, names of the insureds, etc.

The application server 204 may further include an interface that links the client device 202 to the insurance provider 206 to convey commands and information or data between the client device 202 and the insurance provider 206, such as notifications, sharing, uploading, downloading, importing, etc., through a distributed network or the Internet. The communication exchanged between the client device 202 and the insurance provider 206 may occur through an extensible markup language (XML), hypertext markup language (HTML), applets, etc., and may include the ability to change and update content dynamically.

FIG. 3 provides a block diagram of a menu-driven process executed by an insurance shopping client according to an embodiment of the present invention. The exemplary menu driven-process may begin when a user opens an insurance shopping client 302 that comprises a graphical user interface that presents choices of commands, available options, or hyperlinks for registration/login 304, purchase 306, extend policy 308, and cancel/withdraw policy 310. Registration/login 304 may be presented to a user prior to allowing a user to access the other menu items, for example, first-time users making a purchase. The registration/login 304 may allow a new user to register for an account or an existing user to log in with, for example, a username/email and password. Registration for an account may include entering an email, password, and creating a user profile. Creating a user profile may include providing a full name, company name, address, telephone number, and payment method. Additionally, the user may be asked a series of question to determine coverability, such as whether he/she has ever purchased business insurance before, and if yes, whether he/she had any losses totaling more than a certain amount, such as $15,000 over the last three years.

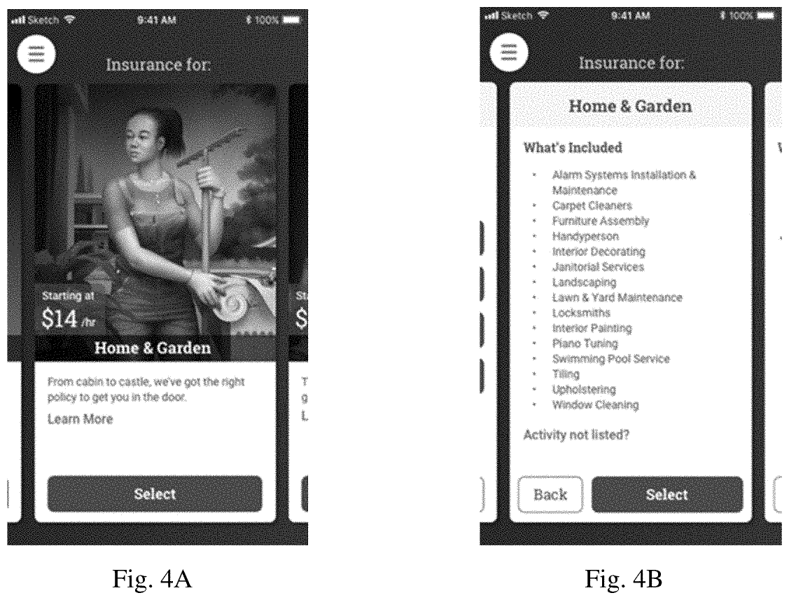

Purchase 306 may direct a user to select a group from a carousel of groups via group and partner selection 312. Users may swipe left and right to view group descriptions, more information, and select a group or partner. FIG. 4 presents an exemplary “Home & Garden” group card. The illustrated card includes an hourly price and a brief description. A user may tap “Learn More” which may flip over the card and displays group level “Included Activities” (FIG. 4B).

The carousel of groups may comprise risk groups of many related activities that are created and labeled with broad names to reflect the general category of work that a user could self-identify with. Each group can contain one or more ISO classes. Within these groups are the classes for the activities included. For example:
construction (carpentry, finishing, electrical, flooring, siding and walls);
professional services (photography, videography, hair stylists, nail artists, yoga/personal training, Computer programming, support, and repair);
home and garden (jobs in and around the house including handiwork, furniture assembly, painting, landscaping, and lighting);
pets (grooming, training, walking, sitting); and
events and entertainment (event planning and staffing, entertainment (e.g., musicians, magicians, DJ's, nature guides and tours).

Based on the defined groups and their constituent risk classes, a predetermined weighting factor may be applied to each of the classes in the group. Below is an example of a possible weighting for a construction group:

TABLE 1

| Class Code | Class Description | Weight |
|---|---|---|
| 91341 | Carpentry - interior | 11.122% |
| 91342 | Carpentry | 5.100% |
| 94444 | Contractors | 5.100% |
| 91805 | Draftsmen | 0.442% |
| 92451 | Electrical Apparatus - installation, servicing | 0.375% |
| | or repair | |
| 92478 | Electrical Work - within buildings | 40.444% |
| 94569 | Floor Covering Installation - not ceramic tile | 2.796% |
| | or stone | |
| 13590 | Glass Dealers and Glaziers | 2.603% |
| 97447 | Masonry | 5.532% |
| 98305 | Painting - interior - buildings or structures | 7.139% |
| 98967 | Siding Installation | 1.187% |
| 99003 | Sign Painting or Lettering - inside of buildings | 2.917% |
| 99004 | Sign Painting or Lettering - on buildings or | 2.917% |
| | structures | |
| 98698 | Salvage Operations | 9.562% |
| 98699 | Salvage Operations - removing, sorting, | 0.180% |
| | reconditioning and distributing of merchandise | |
| | in damaged buildings and incidental | |
| | operations away from such buildings | |
| 99471 | Surveyors - land - not engaged in actual | 2.403% |
| | construction | |
| 92338 | Dry Wall or Wallboard Installation | 0.180% |
| | | 100.000% |

In this case, a relative weighting of these activities within the group called “construction” may be determined. There are many possible ways to establish these weightings. One method is to use U.S. census payroll data. A company in the construction business may be estimated to closely resemble other businesses in the US. By using census data for businesses in each of these individual lines of business, a normalized relative contribution of the revenues toward an overall weighting in this group can be established. The purpose of this, is to estimate exposure for policy rating.

Many small businesses that can benefit from the disclosed system perform jobs for other companies as subcontractors. Some contractors are very large and have specific insurance requirements that their subcontractors must satisfy in order to be assigned the work. An example is a large field services firm that uses independent contractors to perform work. National firms that do this kind of work could subcontract to tens of thousands of vendors. In addition to having specific insurance requirements, these companies may have their own terminology for the kinds of work orders they assign to the subcontractors.

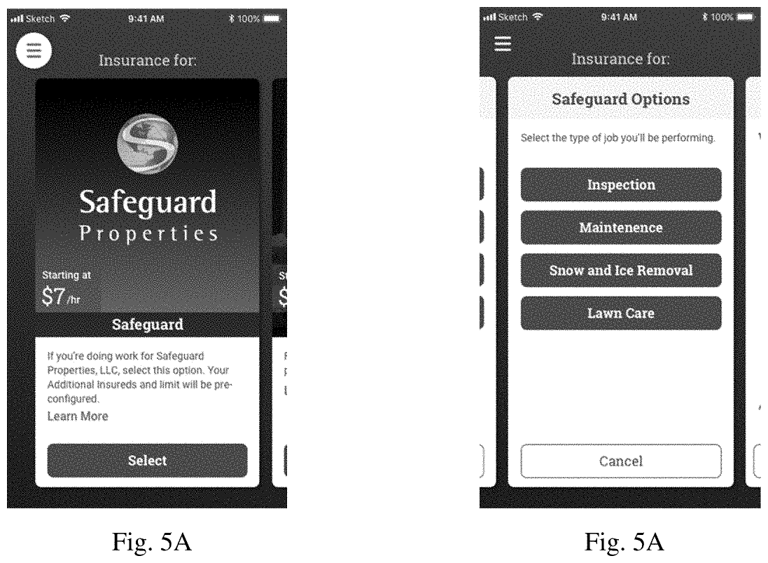

FIG. 5A presents an option for selecting a custom group according to an embodiment of the present invention. A fictional field services company, “Safeguard Properties, LLC” might have work orders called “inspection,” “lawn care,” “snow removal,” “maintenance,” etc. (FIG. 5B). Custom groups may be created specifically for a company like “Safeguard Properties.” This allows subcontractors working for this field services company to have a selection of activities available to them that match exactly the terminology used by the company itself. By understanding the nature of the risks for each of the company's own terminology, custom groups may be created to match the work being done.

In the “Safeguard Properties” example, their work order types become risk groups in the system and might consist of the following risk classes:
Safeguard Properties Inspection: 96317, 96611, 99471;
Safeguard Properties Lawn care: 97050, 97047;
Safeguard Properties Snow removal: 99310; and
Safeguard Properties Maintenance: 95625, 99505, 92338, 98305.

If a worker receives a job request from “Safeguard Properties,” the system may present them with the list of work order types that “Safeguard Properties” uses. By creating these risk group mappings, a purchaser may be provided with easier selections. By making the group selection process simple users can accurately choose the risk activities to a) make sure they are properly covered, b) the insurance carrier to charge the correct premium for the selected risk, c) make sure the limits or other parameters required by the company are set correctly and d) set the additional insured to the company (i.e., “Safeguard Properties”) using language that the company requires.

The disclosed system may also be customized for “Marketplace Vendors.” Today, there are hundreds of web site/businesses that help match work with workers. Examples might include “Uber,” “Lyft,” “Handy,” “Thumbtack,” “Yelp,” “Task Rabbit,” “Amazon Home Services,” etc. These marketplaces have become a convenient way for small businesses to get matched up with people and companies who need projects/jobs completed. In a similar fashion that the system handles company subcontractors, custom risk groups may be created to match the kinds of work that these platforms provide. For example, “Amazon Home Services” may have the following types of jobs that can be done on their marketplace:
Assembly;
Business and Commercial;
Home Improvement;
Home Theater;
House Cleaning; and
Professional Services.
   Accordingly, “Amazon Home Services” vendors may be provided with a simple and intuitive list of selections without them having to know exactly all of the risk classes associated with these work orders.

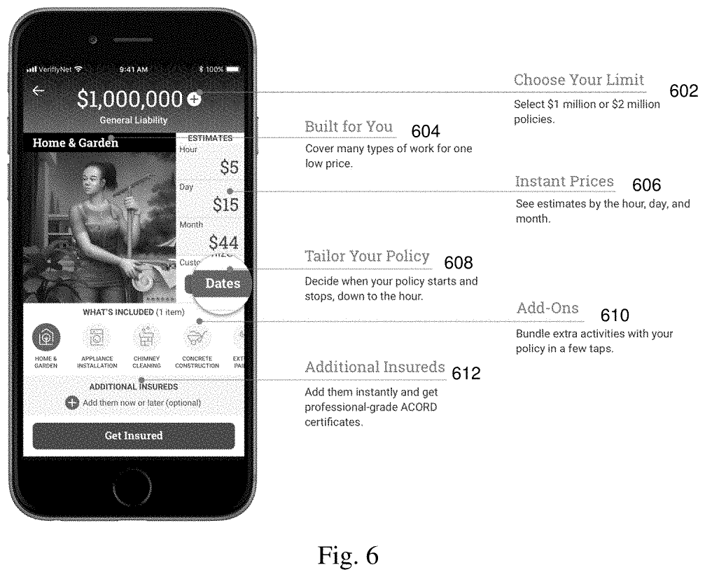

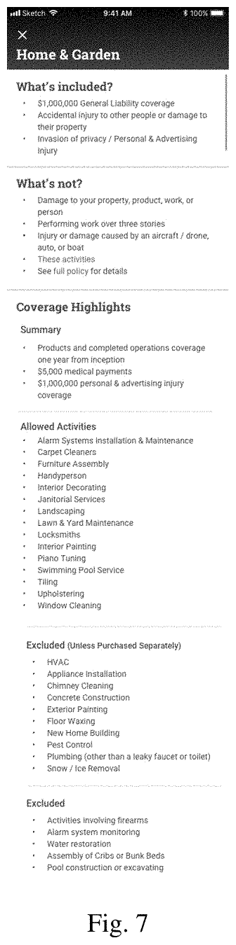

The user may land on an interface provided by policy builder 314 upon selecting a group. FIG. 6 presents an exemplary policy builder interface that may allow a user to construct and purchase their policy. The user may view a group package to increase/decrease limits 602, select a type of work 604, view hour/day/week prices for group/territory 606, select policy period 608, add optional activities 610, and add additional insureds 612. The user may accept a quote for the group package and proceed to purchase confirmation. FIG. 7 presents exemplary description and coverage that may be provided for a given group. Coverage may include certain allowed and excluded activities that are insured under the policy for a particular group.

In addition to the standard list of activities, one or more excluded activities may be added as optional activities to a policy. By allowing a separate purchase of certain “add-on” activities, people may be allowed to engage in higher-risk activities to acquire the proper insurance coverage while balancing groups with classes with loss costs within a similar range. When creating the groups as described above, the inclusion of activities into a single group is balanced with the fact that some activity classes' loss costs are so high as to skew the overall loss cost of the group, making the premium of that group potentially too expensive for people who do not conduct the activity. For example, a class called “Snow and Ice Removal” may have a very high loss cost and may be double the loss cost of the overall, weighted group. By making snow and ice removal as an “add on,” avoids penalizing the businesses that are not involved in this activity in the overall group.

Add-on's may also be created into small groups. For example, an “Appliance Installation” add-on can include activities all associated with appliance installation. This allows a collection of a higher premium on the higher risk activity of appliance installation while not penalizing, with a higher premium, businesses that do not perform appliance installation. There are also various possible methods by which the loss costs of these add on activities may be integrated into the overall group. One approach is to use the highest loss cost of either the weighted risk group or the new add-on. Another way is to re-weight the group to include the new risk classes represented by the add-ons.

With each of the groups associated with a policy, one or more exclusions may apply. Policy level exclusions may be exclusions at the highest level. Regardless of the risks configured on the policy, these policy exclusions are generally applied. Examples include: injury or damage caused by an aircraft, auto, or boat; drones; activities involving firearms, fireworks, or fire; and performing exterior work over three stories.

Group level exclusions may be exclusions that are added to a policy and are specific to the group risks configured on the policy. For example, construction risk group may have exclusions of foundation repair, roofing involving hot tar or membrane work, and grading or excavating. According to another example, home and garden risk group may have exclusions of foundation repair, roofing involving hot tar or membrane work, grading or excavating, alarm system monitoring, water restoration, assembly of cribs or bunk beds, and pool construction. Another type of exclusion may be add-on exclusions. For example, an add-on for “floor waxing” may have the following exclusions: operations including commercial buildings with heavy foot traffic (e.g. malls, grocery/convenience stores, hospitals, airports). Examples of exclusions are listed in the appendix of the present disclosure.

A user may be presented with all exclusions prior to purchasing a policy. This allows the user to make sure that these exclusions do not adversely affect their work. When a policy is purchased, the system generates endorsements that exclude these activities explicitly. It is these endorsements that modify the legal contract between the purchaser (insured) and the carrier (insurance company).

Coverage package 316 may generate a quote based on the group selection, add-on's, exclusions, a policy duration, and calculate a premium for a policy. According to one embodiment, policies may be sold in “bite-size” chunks to allow for short duration terms. The disclosed system has the ability to take policies that have traditionally been sold annually and create, price and sell them in increments as short as one hour. Concentration ratios may be used to adjust the census data annual exposure downward to an appropriate amount commensurate with the risk associated for a short duration (episodic) policy period.

An example using the concentration ratio is shown below for a $1,000,000 limit policy covering a lawn care person in territory 501.

$$\begin{matrix}Minimum premium = ( Annual Exposure ) \times ( Concentration Ratio ) \times \\ ( Loss Cost Multipliers ) \times ( Loss Cost ) \\ = ( \$ \text{37,228} / 1000 ) \times ( 1 \% ) \times ( 1.945 ) \times ( \$12 .06 ) \\ = \$8 .73\end{matrix}$$

As an example, if the Annual Exposure is taken from U.S. Census data for NAICS code ‘561730’—Landscaping Services, the loss cost is equal to the base loss cost for ISO code ‘97050’ in territory ‘501’, $8.04, times the increased limits factor for $1,000,000, 1.50. The concentration ratios may not be directly calculated, but rather selected based on judgment after considering a number of factors that relate to the risk exposure associated with short duration policies. The table below shows one approach to identifying and assign a quantification to important risk factors contemplated in the concentration ratios. This is not the only approach that could be taken. Each of these items are briefly explained in the paragraphs that follow Table 2 along with the rationale for the selected adjustment.

TABLE 2

| | Hour | | Day | | Week | | Month | |
|---|---|---|---|---|---|---|---|---|
| 1. Pro-Rata | 0.01% | | 0.27% | | 1.92% | | 8.33% | |
| as to Time | | | | | | | | |
| 2. Pro-Rata | 0.05% | | 0.40% | | 2.00% | | 8.33% | |
| Comm'l Hours | | | | | | | | |
| 3. Return on | 0.20% | | 1.20% | | 4.00% | | 11.00% | |
| Capital | | | | | | | | |
| 4. Tail Factor | +100% | +20% | +75% | +30% | +45% | +15% | +5% | 0% |
| | 0.40% | 0.30% | 2.10% | 1.56% | 5.80% | 4.60% | 11.55% | 11.00% |
| 5. Moral | +75% | +30% | +20% | +25% | +25% | +10% | +5% | 0% |
| Hazard | 0.70% | 0.39% | 3.15% | 1.95% | 7.25% | 5.06% | 12.13% | 11.00% |
| 6. Start- | +100% | +15% | +100% | +15% | +100% | +15% | +100% | +15% |
| Up/Inexperience | 1.40% | 0.45% | 6.30% | 2.24% | 14.50% | 5.82% | 24.26% | 12.65% |
| 7. Lack of | +20% | +5% | +20% | +5% | +20% | +5% | +20% | +5% |
| control | 1.68% | 0.47% | 7.56% | 2.35% | 17.40% | 6.11% | 29.11% | 13.28% |

| | | | | |
|---|---|---|---|---|
| 8. Selection | 1% | 5% | 10% | 15% |

Item (1)—Pro-Rata as to Time—The default option for adjusting pricing for other-than-annual policy periods is straight pro-rata as to time. This assumes that the exposure is even throughout the year and that insured who purchase an eleven or thirteen month policy are essentially no different than those purchasing twelve month policies. The factors in row #1 are the adjustments to annual exposure assuming 365 days per year and 24 hours per day (1/(365×24)=0.01% and 24/(365×24)=0.27%).

Item (2)—Pro-Rata Commercial Hours—General liability policies are applicable to commercial entities (or individuals involved in business). When adjusting payroll (or sales), it is assumed that the exposure is earned over an eight hour day, five days per week and fifty weeks per year. Therefore, the hourly exposure would be 1/(8×5×50)=0.05% and a daily exposure would equal 8/(8×5×50).

Item (3)—Return on Capital—This addresses the issue of comparing portfolios where the limit remains constant but the premium substantially declines. In other words, comparing a standard portfolio to a portfolio of catastrophe contracts (or low rate-on-line contracts). A catastrophe book of business requires greater capital than a non-catastrophe exposed book.

The adjustment factors on row #3 were determined using a simulation model to compare books of business written at the different durations and equivalent underlying assumptions. According to a simulation, the average simulated loss ratio (last row in the table) is roughly the same for all policy durations. However, the distribution of loss ratios is significantly different. The 1-in-1,000 scenario for the annual policies is a 177% loss ratio, while the corresponding hourly loss ratio is 10,601%. Such a loss ratio would require significantly more capital relative to the premium volume. As a consequence, the smaller premiums associated with the shorter duration policies result in an average margin that is much smaller relative to the potential downside. Using a coherent capital requirement, such as tail value at risk (TVAR), the return on capital for the short duration contracts is much lower than that of the annual policies. The return on capital at a 98% TVAR decline as the policy durations get shorter and the portfolio becomes more catastrophe-like.

Item (4)—Tail Factor—The products and completed operations policy form can be modified to cover completed operations claims for twelve months after policy inception. This coverage for completed operations is much longer than the policy duration. An hour policy will still have a full year of coverage for products despite the reduction to the products portion of the policy premium. Offsetting this extension is that the products coverage relates to activities during the policy period (and not products created prior or subsequent). The twelve month period runs from inception and so is much greater relative to an hourly policy as compared to a monthly policy. Recognizing that products and completed operations is only a portion of the general liability exposure, but that twelve months is extremely long compared to an hour of premises and operations coverage, an adjustment of 100% may be selected for the hour policy and reduced that adjustment for the longer day, week, and month duration policies.

Item (5)—Moral Hazard—This feature may allow instant purchase of insurance for very low prices (e.g., as low as $5 for $1 m of limit). The potential risk that people will purchase this cover at times when hazards are particularly acute is substantial. That risk is lower for the month duration contracts and heightened for the shortest one hour policies. An adjustment of up to 75% may be selected for the one hour policies with smaller adjustments for the longer periods.

Item (6)—Start-Up/Inexperience—the target insureds will generally have higher risk characteristics, e.g., single person operations with less experience and little training. Within an insurance program start-up business are generally incur a surcharge relative to on-going enterprises. In many cases, a start-up program will not receive quotes for coverage in the traditional markets and will have to resort to non-standard or excess and surplus lines carriers where prices will be higher and coverage is likely restricted. The adjustments in item (6) range from +15% representing a within program start-up surcharge to +100% representing pricing in an alternative market.

Item (7)—Lack of Control—policies in this episodic feature can be purchased by customers using a simplified application and algorithms based on those inputs. There may not be specific underwriting decisions or controls associated with each purchase. This process creates greater uncertainty in the portfolio of exposures, their classification, and risk-based pricing. Adjustment associated with this feature can be +5% to +20%.

The combination of the factors described above results in ranges for indicated concentration ratios at each policy duration.

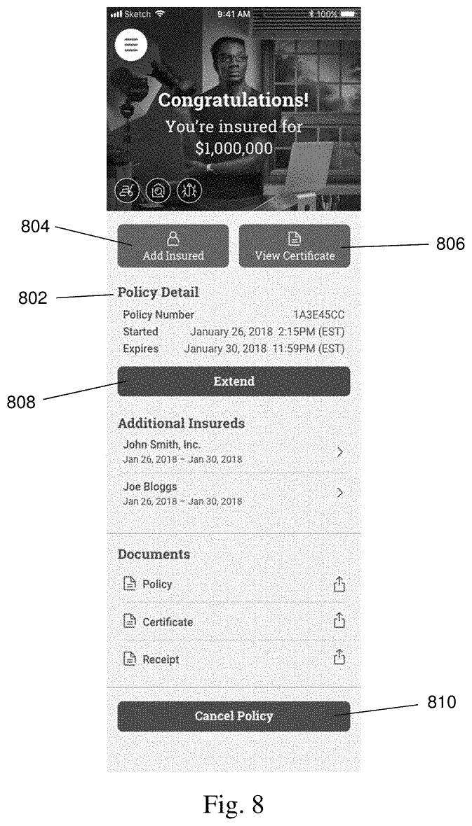

Referring back to FIG. 3, the user may proceed to checkout 320 to purchase a policy based on the quote. The user may be presented with payment options to proceed with the purchase. Payment information may also be solicited and verified by checkout 320 to complete the purchase. Once the purchase is complete, the user may land on active policy 308 which may provide an active policy screen as illustrated in FIG. 8. According to FIG. 8, a user may view policy details 802, additional insureds 804, view a certificate of insurance 806, extend the policy 808, and cancel the policy 810.

The user may be provided with an option to view or download policy documents via documents 310. Additionally, the user may proceed to extend policy 322. Checkout 324 may be initiated and present the user with a checkout screen to select an hourly duration or new end date to extend the policy. In one embodiment, no details other than the end date and/or time will be able to be modified for the extension. The user may be presented with payment options to complete the extension.

The user may also proceed to cancel/withdraw policy 326 to cancel an active policy or withdraw a policy scheduled to activate. A policy may be withdrawn up to a certain amount of time, for example, one hour before inception. Once a policy begins, it may not be cancellable or refundable. For policies with total policy duration including extensions that are less than a specific duration in time, for example, 24 hours, may not be cancellable or refundable. Upon confirmation of cancellation or withdrawal, the system may proceed to refund 328 to refund either a pro-rated or full amount to the user's account. If the policy has additional insureds with email addresses, they may be notified. The system may proceed to add insured 330 if the user decides to add additional insureds to the existing policy.

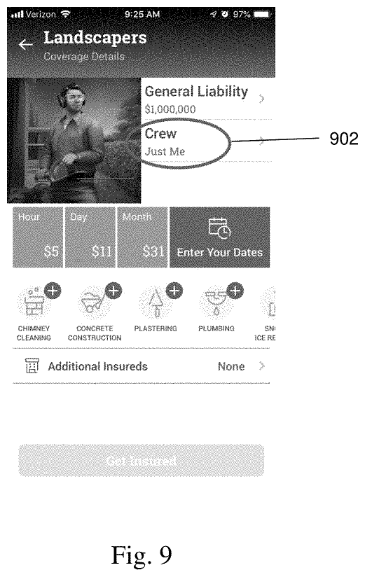

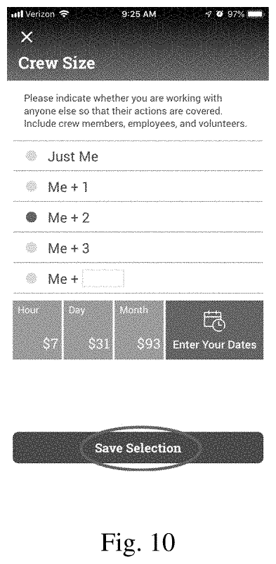

FIGS. 9 and 10 present exemplary screens for crew coverage according to an embodiment of the present invention. Policy coverage for crew members may be supported for coverage under a policy. A crew includes anyone a policy purchasing-user is working with whose actions related to the covered activities. The user may be prompted to add a crew 902 when purchasing a policy. As illustrated in FIG. 10, the user may indicate coverage for a number of other people working with the user. Pricing for additional members for a crew may be priced on a per person basis, for example, a base premium multiplied by a number of people under the policy (user and crew members). In some embodiments, a discount may be applied to a policy for crew members that exceed a certain number.

FIGS. 1 through 10 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps). In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer-readable program code) are stored in a main and/or secondary memory, and executed by one or more processors (controllers, or the like) to cause the one or more processors to perform the functions of the invention as described herein. In this document, the terms “machine readable medium,” “computer-readable medium,” “computer program medium,” and “computer usable medium” are used to generally refer to media such as a random access memory (RAM); a read only memory (ROM); a removable storage unit (e.g., a magnetic or optical disc, flash memory device, or the like); a hard disk; or the like.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

### APPENDIX

### Policy-Level Exclusions

### General Liability Exclusions

Damage to your property, product, work or person
Injury or damage caused by an aircraft/drone, auto, or boat
Activities involving firearms
Performing work over three stories

### Group-Level Inclusions & Exclusions

| | | “Excluded (Unless | “Excluded” (Exclusions/ |
|---|---|---|---|
| Group | “Allowed Activities” | Purchased Separately)” | Endorsement Contents) |
| Common | Accidental injury to others | HVAC | <<Activities Excluded If |
| | or damage to their | Appliance | Not Paid>> |
| | property | Installation | <<Policy-Level |
| | Products and completed | Chimney Cleaning | Exclusions>> |
| | operations coverage for a | Concrete | <<Optional Activity |
| | year from inception | Construction | Exclusions>> |
| | Invasion of Privacy/ | Exterior Painting | |
| | Personal & Advertising | Floor Waxing | |
| | Injury | New Home | |
| | | Building | |
| | | Pest Control | |
| | | Plastering | |
| | | Plumbing (other | |
| | | than a leaky faucet | |
| | | or toilet) | |
| | | Snow/Ice Removal | |
| Construction | 1. Carpentry | | 1. Foundation repair |
| | 2. Finish Carpentry | | 2. Roofing involving |
| | 3. Closets | | hot tar or |
| | 4. Contractors | | membrane work |
| | 5. Door Installation | | 3. Grading or |
| | 6. Finishing Contractors | | excavating |
| | 7. Fence Building | | |
| | 8. Deck Building | | |
| | 9. Draftsperson | | |
| | 10. Electrical | | |
| | 11. Flooring | | |
| | 12. Glaziers | | |
| | 13. Gutter Cleaning | | |
| | 14. Masonry | | |
| | 15. Millwork | | |
| | 16. Interior Painting | | |
| | 17. Siding | | |
| | 18. Salvage Ops | | |
| | 19. Surveyors | | |
| | 20. Walls (Drywall or | | |
| | Wallboard) | | |
| | 21. Window Dressing | | |
| Events & | 1. Individual event | | 1. Acrobatic, |
| Entertainment | participants (not the event | | aerialist, or stunt |
| | itself) | | performers |
| | 2. Event staff, planners, and | | 2. Amusement |
| | promoters (as individuals) | | device, rides or |
| | 3. Musicians | | inflatables operators |
| | 4. Magicians | | 3. Operations |
| | 5. DJ's | | involving non- |
| | 6. Actors | | domestic animals |
| | 7. Speakers | | 4. Exotic dancers, |
| | 8. Entertainers | | strippers, or adult |
| | 9. Canoe & Kayak Guides | | entertainment |
| | 10. Fishing Guides | | 5. Operations |
| | 11. Float Trip Guides | | involving weapons |
| | 12. Hiking Tour Guides | | 6. Hypnotists |
| | 13. Nature and wildlife | | 7. ATV tours |
| | Guides | | 8. Horseback trail |
| | 14. Stand Up Paddleboard | | rides |
| | (SUP) Guides | | 9. Hunt clubs |
| | | | 10. Rock climbing |
| | | | 11. Skiing or |
| | | | Snowboarding |
| | | | 12. White water |
| | | | rafting |
| Home & | 1. Alarm or Fire System | | 1. Foundation repair |
| Garden | Installation & | | 2. Roofing involving |
| | Maintenance | | hot tar or |
| | 2. Surveillance System | | membrane work |
| | Installation & | | 3. Grading or |
| | Maintenance | | excavating |
| | 3. AV Installation | | 4. Alarm system |
| | 4. Smart Home Installation | | monitoring |
| | 5. Invisible Fence ® | | 5. Water restoration |
| | Installation | | 6. Assembly of cribs |
| | 6. Carpet Cleaners | | or bunk beds |
| | 7. Furniture Assembly | | 7. Pool construction |
| | 8. Gutter cleaning | | |
| | 9. Handyperson | | |
| | 10. Interior Decorating | | |
| | 11. Interior Painting | | |
| | 12. Janitorial Services | | |
| | 13. Landscaping | | |
| | 14. Lawn & Yard | | |
| | Maintenance | | |
| | 15. Locksmiths | | |
| | 16. Lighting Installation | | |
| | 17. Piano Tuning | | |
| | 18. Swimming Pool Service | | |
| | 19. Tiling | | |
| | 20. Upholstering | | |
| | 21. Window Cleaning | | |
| Pets | 1. Grooming | | |
| | 2. Training | | |
| | 3. Walking | | |
| | 4. Sitting | | |
| Professional | 1. Photographer/ | | 1. Adult film |
| Services | Videographer | | operations |
| | 2. Computer programmer | | 2. Bartenders |
| | 3. Computer repair | | 3. Inspectors |
| | 4. Food/Catering | | 4. Massage therapists |
| | 5. Hair stylists | | 5. Occupational |
| | 6. Nail Artists | | therapists |
| | 7. Office machine | | 6. Physical therapists |
| | installation and repair | | 7. Tattoo or piercing |
| | 8. Personal trainers | | artists |
| | 9. Printing | | |
| | 10. Sign Installation | | |
| | 11. Web developer | | |
| | 12. Yoga Instructor | | |

### Optional Activity Descriptions & Questions

| | | | | | Optional |
|---|---|---|---|---|---|
| Optional | | | | Question 2 | Activity |
| Activity | Intro | Description | Question 1 | (Slide to Agree) | Exclusions |
| Plumbing | Work with pipes, | | I am properly licensed, | My work will not | LPG (propane) |
| | water or sewage? | | if necessary. | include LPG (propane) | connections. |
| | Don't get submerged, | | | connections. | |
| | get covered. Not | | | | |
| | required for simple | | | | |
| | faucet and toilet leaks. | | | | |
| Snow/Ice | When it starts | | My work will not | My work will not | Snow/Ice |
| Removal | snowing, you start | | include commercial | include multi-unit | removal |
| | working. Start here to | | property. | residential (e.g. | including |
| | make sure you're | | | apartments, condo's). | commercial |
| | covered. | | | | property or |
| | | | | | multi-unit |
| | | | | | residential. |
| Appliance | Appliances make life | | | | |
| Installation | so much easier. So | | | | |
| | does the right | | | | |
| | coverage. | | | | |
| Chimney | Dirty chimneys equal | | I am properly licensed, | My work will be under | Performing work |
| Cleaning | good money. Get the | | if necessary. | three stories. | over three |
| | right coverage and get | | | | stories. |
| | cleaning. | | | | |
| Concrete | Concrete can be hard. | | I am properly licensed, | My work will not | Foundation |
| Construction | Getting covered to | | if necessary. | involve foundation | repair. |
| | work with it is not. | | | repair. | |
| | Includes making, | | | | |
| | setting up or taking | | | | |
| | down forms, | | | | |
| | scaffolds, falsework | | | | |
| | and concrete | | | | |
| | distributing apparatus. | | | | |
| Floor Waxing | Before making nice, | | My work will not | My work will not | Floor waxing |
| | shiny floors, cover | | include work for a | include commercial | operations |
| | yourself with a nice, | | business performed | buildings with heavy | including |
| | shiny policy. | | during business hours. | foot traffic (e.g. malls, | commercial |
| | | | | grocery/convenience | buildings with |
| | | | | stores, hospitals, | heavy foot traffic |
| | | | | airports). | (e.g. malls, |
| | | | | | grocery/ |
| | | | | | convenience |
| | | | | | stores, hospitals, |
| | | | | | airports). |
| Pest Control | Go get 'em! But first, | Herbicide | I am properly licensed, | My work will not | Termite or bed |
| | get yourself covered. | Pesticide | if necessary. | include termite or bed | beg remediation. |
| | Includes herbicide and | Rodents | | bug remediation. | |
| | pesticide | Insect | | | |
| | applications, rodent, | Bats | | | |
| | insect and bat | | | | |
| | removal. | | | | |
| Plastering | If you're a master | Plaster | My work will not | | Operations |
| | with plaster, start by | Stucco | include E.I.F.S. | | including |
| | covering yourself with | | (synthetic stucco). | | E.I.F.S. |
| | the right policy. | | | | (synthetic |
| | | | | | stucco). |
| HVAC | The right coverage | Heating | I am properly licensed, | | |
| | will make sure it all | Ventilation | if necessary. | | |
| | flows well. | Air | | | |
| | | Conditioning | | | |
| New Home | Before the walls go in | Construction | My work will not | | New residential |
| Building | place, put the right | of new | include work on 10 or | | construction |
| | policy in place. | residential | more homes or units in | | where the |
| | | properties. | any one project or | | insured is |
| | | | development. | | working on 10 or |
| | | | | | more homes or |
| | | | | | units in any one |
| | | | | | project or |
| | | | | | development. |
| Exterior | It's what's on the | | My work will be under | | Performing work |
| Painting | outside that counts, | | three stories in height. | | over three stories |
| | especially when | | | | in height. |
| | painting homes or | | | | |
| | businesses under three | | | | |
| | stories. Get covered | | | | |
| | here. | | | | |

### Compliance Example

### Assumptions

General Liability policy
$1,000,000 aggregate limit
$1,000,000 PAI limit
$5,000 Medical Payments sub-limit
Start=Now
Duration=8 hours
Group=Home & Garden
Optional Activities=Plastering

| | Purchase Confirmation: Checkout Details |
|---|---|
| Policy | Starts Now/Ends in 8 hours. |
| Period | |
| Basic | What's included? |
| Coverage | $1,000,000 General Liability coverage |
| | Accidental Injury to other people or damage to |
| | their property |
| | Invasion of privacy/Personal & Advertising Injury |
| | What's not? |
| | Damage to your property, product, work, or person |
| | Performing work over three stories |
| | Injury or damage caused by an aircraft/drone, |
| | auto, or boat |
| | These activities |
| | See full policy for details |
| Underwriter | Underwritten by Markel Insurance Company |
| Declaration | |
| Insureds | Named Insured: John Smith |
| | Additional Insureds: John Smith, Inc., Joe Bloggs |
| Coverage | Products and completed operations coverage one |
| Highlights: | year from inception |
| Summary | $5,000 medical payments |
| | $1,000,000 Personal & Advertising Injury coverage |
| | This policy is not cancellable or refundable. |
| Coverage | Alarm Systems Installation & Maintenance |
| Highlights: | Carpet Cleaners |
| “Allowed | Furniture Assembly |
| Activities” | Handyperson |
| | Interior Decorating |
| | Janitorial Services |
| | Landscaping |
| | Lawn & Yard Maintenance |
| | Locksmiths |
| | Interior Painting |
| | Piano Tuning |
| | Swimming Pool Service |
| | Tiling |
| | Upholstering |
| | Window Cleaning |
| | Plastering |
| Coverage | HVAC |
| Highlights: | Appliance Installation |
| “Excluded | Chimney Cleaning |
| (Unless | Concrete Construction |
| Purchased | Exterior Painting |
| Separately)” | Floor Waxing |
| | New Home Building |
| | Pest Control |
| | Plumbing (other than a leaky faucet or toilet) |
| | Snow/Ice Removal |
| Coverage | Activities involving firearms |
| Highlights: | Operations involving drones |
| “Excluded” | Performing work over three stories |
| | Alarm system monitoring |
| | Water restoration |
| | Assembly of Cribs or Bunk Beds |
| | Pool construction or excavating |

What is claimed is:

1. A system comprising:
an application server configured to communicate with a client application of a client device that presents an interface for purchasing an insurance policy, the interface comprising a graphical representation including: a carousel for selecting one of a plurality of risk groups, an amount of coverage, and a coverage term on an hourly, daily, or monthly duration, wherein the plurality of risk groups include classes of occupational activities to be covered in the insurance policy, the application server comprising:
a quoting service component configured to: receive a selection of risk group, amount of coverage, and coverage term from the interface, and generate quote data using a concentration ratio of an annual exposure based on the selected risk group, amount of coverage, and the coverage term;
a payment service component configured to solicit payment for the insurance policy based on the quote data, process the payment, and facilitate coverage under the insurance policy; and
an account management service component configured to transmit details of the insurance policy to the client application and facilitate requests for extending the coverage term of the insurance policy.

2. The system of claim 1 wherein the quote data is used by the client application to generate a graphic representation of an insurance product offering on the interface.

3. The system of claim 1 wherein the quote data includes one or more of vector graphics data, markup language data, graphics, and images.

4. The system of claim 1 wherein the quote data includes coverage, pricing, and duration based on information provided from programmable business rules and databases.

5. The system of claim 1 wherein the application server further comprises a customer service component configured to establish communication with a call center via the client application.

6. The system of claim 5 wherein the customer service component is further configured to render proof of insurance identification cards or documents.

7. The system of claim 1 wherein the carousel includes one or more risk group cards including pricing, risk group description, and activities associated with a given risk group.

8. The system of claim 1 wherein a risk group includes a plurality of constituent risk classes wherein a predetermined weighting factor is applied to each of the constituent risk class.

9. The system of claim 1 wherein the plurality of risk groups includes a custom group associated with work order types of a company and including risk classes specified according to the company.

10. The system of claim 1 wherein the plurality of risk groups include policy level exclusions.

11. The system of claim 1 wherein the plurality of risk groups include group level exclusions that are added to the insurance policy and are specific to group risks configured on the insurance policy.

12. The system of claim 1 wherein the insurance policy is extended an hourly duration or a new end date.

13. The system of claim 1 wherein the insurance policy includes coverage for one or more crew members.

14. Non-transitory computer-readable media comprising program code that when executed by a programmable processor causes execution of a method for presenting an interface on a client device, the computer-readable media comprising:
computer program code for communicating with a client application of a client device that presents an interface for purchasing an insurance policy, the interface comprising a graphical representation including: a carousel for selecting one of a plurality of risk groups, an amount of coverage, and a coverage term on an hourly, daily, or monthly duration, wherein the plurality of risk groups include classes of occupational activities to be covered in the insurance policy;
computer program code for receiving a selection of risk group, amount of coverage, and coverage term from the interface;
computer program code for generating quote data using a concentration ratio of an annual exposure based on the selected risk group, amount of coverage, and the coverage term;
computer program code for soliciting payment for the insurance policy based on the quote data, process the payment, and facilitate coverage under the insurance policy;
computer program code for transmitting details of the insurance policy to the client application; and
computer program code for facilitating requests for extending the coverage term of the insurance policy.

15. The non-transitory computer-readable media of claim 14 wherein the quote data includes coverage, pricing, and duration based on information provided from programmable business rules and databases.

16. The non-transitory computer-readable media of claim 14 wherein the carousel includes one or more risk group cards including pricing, risk group description, and activities associated with a given risk group.

17. The non-transitory computer-readable media of claim 14 wherein a risk group includes a plurality of constituent risk classes wherein a predetermined weighting factor is applied to each of the constituent risk class.

18. The non-transitory computer-readable media of claim 14 wherein the plurality of risk groups includes a custom group associated with work order types of a company and including risk classes specified according to the company.

19. The non-transitory computer-readable media of claim 14 wherein the plurality of risk groups include group level exclusions that are added to the insurance policy and are specific to group risks configured on the insurance policy.

20. The non-transitory computer-readable media of claim 14 wherein the insurance policy includes coverage for one or more crew members.
